(19) United States
(12) Patent Application Publication
(10) Pub. No.: US 2008/0226108 A1
(43) Pub. Date: Sep. 18, 2008

(54) Receiver with an additional shielding facility

(76) Inventors: Markus Heerlein, Singapore (SG); Thomas Kasztelan, Erlangen (DE); Wee Haw Koo, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/900,836

(22) Filed: Sep. 13, 2007

(30) Foreign Application Priority Data
Sep. 19, 2006 (DE) 10 2006 043 909.0

(51) Int. Cl. H04R 25/00

(52) U.S. Cl. 381/324

(57) ABSTRACT

The magnetic interference fields, which originate from a receiver in a hearing apparatus and in particular a hearing device, are to be reduced further. To this end, provision is made for a shielding facility to be incorporated into the housing of a receiver in order to magnetically shield between the outer wall with a connecting facility and an electroacoustic converter. The shielding facility can comprise a soft magnetic shielding sheet of high magnetic permeability and/or for instance also a compensation coil.

### CROSS REFERENCE TO RELATED APPLICATIONS

This application claims priority of European Patent Office application No. 102006043909.0 EP filed Sep. 19, 2006, which is incorporated by reference herein in its entirety.

### FIELD OF INVENTION

The present invention relates to a receiver for a hearing apparatus which can be worn in/on the ear having a soft magnetic housing, comprising a connecting facility on an exterior wall, and an electroacoustic converter, which is arranged in the housing and can be controlled from the outside by means of the connecting facility. Furthermore, the present invention relates to a hearing apparatus and in particular a hearing device with a receiver of this type. This receiver can also be used for other hearing apparatuses, such as headsets, earphones and suchlike.

### BACKGROUND OF INVENTION

Hearing devices are portable hearing apparatuses which are used to supply the hard of hearing. To accommodate the numerous individual requirements, different configurations of hearing devices such as behind-the-ear hearing devices (BTE), in-the-ear hearing devices (ITE), concha hearing devices, are provided. The hearing devices designed by way of example are worn on the outer ear or in the auditory canal. Furthermore, bone conduction hearing aids, implantable or vibrotactile hearing aids are also available on the market. The damaged ear is herewith either stimulated mechanically or electrically.

Essential components of the hearing devices include in principal an input converter, an amplifier and an output converter. The input converter is generally a receiving transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This main configuration is shown in the example in FIG. 1 of a behind-the-ear hearing device. One or a number of microphones 2 for recording the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the hearing device. The power supply of the hearing device and in particular of the signal processing unit 3 is carried out by a battery 5 which is likewise integrated into the hearing device housing 1.

An electrodynamic loudspeaker is frequently used as an electroacoustic converter, said loudspeaker using the Lorentz force as the power source. An oscillating coil herewith drives a membrane, which generates the sound. This oscillating coil unintentionally radiates magnetic fields outwards, which interfere with other components of the hearing apparatus and/or hearing device. Telemetric devices, which are integrated in the hearing apparatus, are interfered with for instance by the strong interference field of the receiver with the electromagnetic coil. This is due in particular to the individual components in a hearing device having to be arranged very close to one another.

### SUMMARY OF INVENTION

For shielding purposes, the receivers are thus generally embedded in a soft magnetic housing with high magnetic permeability, which ensures the shielding of the magnetic field. A nickel-iron alloy with approximately 75 to 80% nickel is mostly used as the metal. An alloy of this type is known by the name Mu-Metal (MuMetal®). A corresponding magnetically shielded electroacoustic converter is known from the publication U.S. Pat. No. 4,956,868 A. It has two housing halves with high magnetic permeability.

The shielding housing of a receiver is however generally broken on two sides, namely on the side of the sound outlet and on the side of the electrical connection (see FIG. 2). For this reason, interfering magnetic fields appear on these sides despite the housing. These interfering fields interfere with other hearing device components in their function.

The publication DE 102 36 940 B3 discloses a hearing aid device with a receiver, which is surrounded by a shielding sheet or by a shielding capsule. The hearing aid device also comprises a compensation coil, which is located in front of, next to or behind the receiver. It is however not located within the shielding capsule.

The publication DE 198 54 201 C2 also describes a hearing aid device with an induction coil and/or telephone coil. The device also has a compensation inductor, which is positioned such that its compensation field, during operation of the induction coil, is aligned toward the magnetic field of the receiver, and prevents coupling between the receiver and the induction coil.

The object of the present invention is thus to further reduce the magnetic interferences originating from a receiver.

In accordance with the invention, this object is achieved by a receiver for a hearing apparatus which can be worn in/on the ear having a soft magnetic housing, which comprises an electrical connecting facility on an outer wall, and an electroacoustic converter, which is arranged in the housing and can be controlled from the outside by way of the connecting facility, with a shielding facility being incorporated in the housing in order to magnetically shield between the outer wall with the connecting facility and the electroacoustic converter.

The shielding facility in the receiver housing advantageously outwardly shields at least the part of the magnetic interference field, which would penetrate outwards through and/or on the connecting facility.

The shielding facility preferably contains a magnetic shielding sheet. A magnetic shielding sheet of this type, which can also consist of a Mu-Metal, is very cost-effective and can be installed in a simple manner.

Alternatively or in addition, the shielding facility can comprise an induction coil. In this way the interference field can be actively cancelled by a corresponding opposing field.

The induction coil can consist for instance of an air-core coil. This is advantageous in that it exhibits a very broad distribution.

In particular, the induction coil can be arranged transversely to the magnetic axis of the electromagnetic converter. This is favorable in this respect since the working magnetic field of the electroacoustic converter is to be influenced as little as possible.

According to further preferred embodiment, the induction coil is connected in series with the electroacoustic converter. A minimal circuitry outlay can herewith be realized.

According to a particularly preferred application, the receiver according to the invention is used in a hearing device, which also comprises a telemetric device for electromagnetic communication with an external device. The telemetric device of the hearing device can herewith also be operated in a relatively fail-safe manner.

### BRIEF DESCRIPTION OF THE DRAWINGS

The present invention is described in more detail with reference to the appended drawings, in which:

FIG. 1 shows a schematic diagram of the setup of the electronics system in a hearing device

FIG. 2 shows a receiver with an open housing prior to the installation of a shielding sheet,

FIG. 3 shows a top view onto the receiver in FIG. 2 after the installation of a shielding sheet,

FIG. 4 shows a receiver with an open housing prior to installation of an induction coil and

FIG. 5 shows a top view of the receiver in FIG. 4 after the installation of the induction coil.

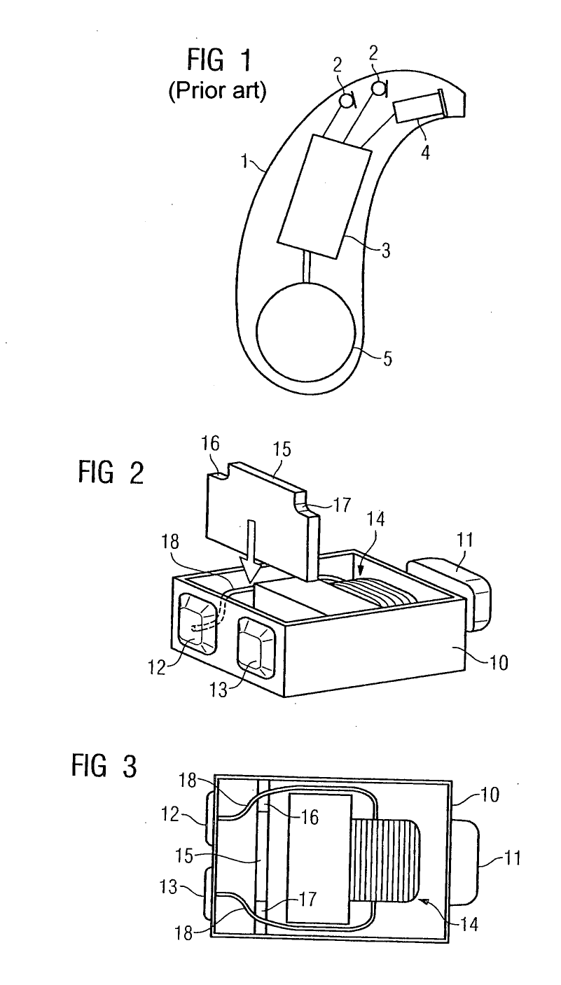

### DETAILED DESCRIPTION OF INVENTION

The exemplary embodiments illustrated in more detail below represent preferred embodiments of the present invention.

FIG. 2 shows a perspective view of a receiver and/or a miniature loudspeaker of a hearing device. It is located in a housing 10 made of Mu-Metal, i.e. the soft magnetic nickel-iron alloy of high magnetic permeability. A sound outlet support 11 is located on the front side of the receiver housing 10. Two connecting contacts 12, 13 are integrated into the housing wall on two opposite sides. These are used to electrically connect the electroacoustic converter 14 located in the housing 10. This electroacoustic converter has a winding, with which an alternating magnetic field can be generated.

During operation of the electroacoustic converter, the magnetic interference fields of the winding of the electroacoustic converter 14 are for the most part shielded by the housing 10. A perceptible leak results however in the region of the electrical contacts 12, 13, which fail to represent any significant magnetic shielding. For this reason, a Mu-Metal sheet 15 is inserted between the electroacoustic converter 14 and the electrical connecting facility, i.e. the electrical contacts 12, 13. On its left and right upper corners, this has a recess 16, 17 in each instance, through which the lacing 18, which connects the contact points 12, 13 with the electroacoustic converter 14, are guided. An arrow in FIG. 2 indicates how the additional shielding sheet 15 is inserted into the housing 10.

For clarification purposes, only the base shell of the housing 10 is indicated, thereby dispensing with the illustration of the housing cover. The view into the interior of the receiver housing is thus free.

FIG. 3 shows a top view of the receiver with an inserted shielding sheet. This perspective clearly shows how the lacings 18 are guided through the recesses 16, 17 from the electroacoustic converter 14 to the contact points 12, 13. The recesses 16, 17 are kept as small as possible so that the shielding of the magnetic interference fields remains as high-quality as possible in the direction of the contact points 12, 13.

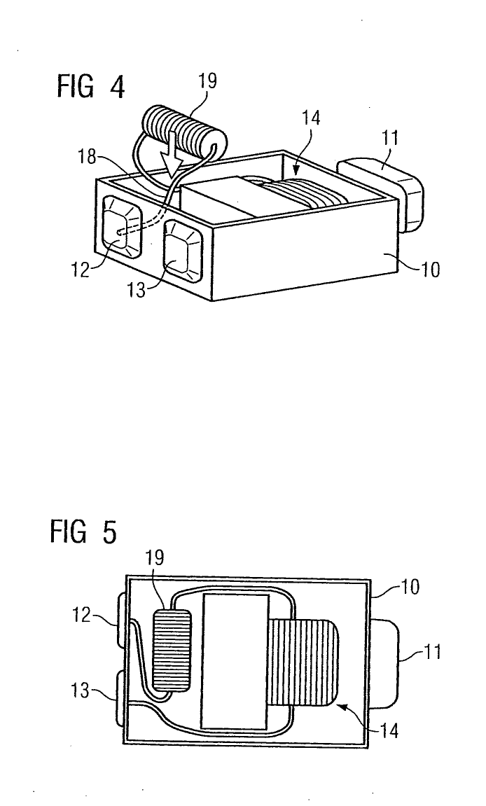

A second exemplary embodiment of a receiver according to the invention is shown in FIG. 4 and FIG. 5. The setup of the receiver essentially corresponds to that illustrated in FIG. 2 FIG. 3. Accordingly, an electroacoustic converter 14 is located in a Mu-Metal housing 10, of which only the base shell is illustrated diagrammatically. The sound outlet support 11 is located on the opposite side to the side with the connecting points 12, 13. The electroacoustic converter 14 is electrically connected to the contact points 12, 13.

Instead of the shielding sheet, an induction coil 19 is inserted here into the housing 10 between the electro acoustic converter 14 and the connecting facility with the connecting points 12, 13, as a shielding facility for the interference fields which appear on the side of the contact points 12, 13 from the housing 10. The induction coil 19 does not function passively like the shielding sheet 15, but instead actively to compensate for the scattered field of the electroacoustic converter 14. This compensation coil nevertheless also operates outwardly like a shielding unit, so that it is understood here as the term shielding facility.

The compensation coil 19 is embodied here as an air-core coil. This means that it does not have any metal core. This is advantageous in that it does not exhibit a relatively high scattering. Depending on requirements, it can also be completely or partially filled with a soft magnetic core.

While the compensation coil 19 is shown in FIG. 4 in its uninstalled state, FIG. 5 shows a top view of the coil in an installed state in the housing 10. This shows how the compensation coil 19 is connected in series to the winding of the electroacoustic converter 14. The compensation results from the fact that the magnetic fields subtract from each other and are thus no longer able to be picked up by the very sensitive telephone coil. The optimal arrangement and alignment of the compensation coil must be individually determined for each receiver.

By virtue of the improved shielding and/or compensation of the interference field of the electroacoustic converter 14, less problems are to be expected with other magnetically sensitive components. Research and development work in respect of new products can herewith be reduced. Clear cost savings for these new products also result herefrom. Furthermore, the shielding and/or compensation first enables telephone coils and/or telemetric units to be integrated into the hearing device for many in-the-ear hearing devices.

1.-7. (canceled)

8. A receiver for a hearing apparatus which can be worn in/on the ear, comprising:
a soft magnetic housing comprising an electrical connecting facility arranged on an outer wall of the housing;
an electroacoustic converter arranged in the housing and controllable from the outside of the house by way of the connecting facility; and
a shielding facility is incorporated inside the housing in order to magnetically shield between the outer wall and the electroacoustic converter.

9. The receiver as claimed in claim 8, wherein the shielding facility comprises a magnetic shielding sheet.

10. The receiver as claimed in claim 8, wherein the shielding facility comprises an induction coil.

11. The receiver as claimed in one of claim 10, wherein the induction coil is connected in series with the converter.

12. The receiver as claimed in claim 10, wherein the induction coil is arranged transversely to a magnetic axis of the converter.

13. The receiver as claimed in claim 10, wherein the induction coil is an air-core coil.

14. The receiver as claimed in one of claim 13, wherein the induction coil is connected in series with the converter.

15. The receiver as claimed in claim 13, wherein the induction coil is arranged transversely to the magnetic axis of the converter.

16. The receiver as claimed in one of claim 15, wherein the induction coil is connected in series with the converter.

17. A hearing device which can be worn in/on the ear, comprising:
a telemetric device for electromagnetic communication with an external device; and
a receiver comprising:
a soft magnetic housing comprising an electrical connecting facility arranged on an outer wall of the housing,
an electroacoustic converter arranged in the housing and controllable from the outside of the house by way of the connecting facility, and
a shielding facility is incorporated inside the housing in order to magnetically shield between the outer wall and the electroacoustic converter.

18. The hearing device as claimed in claim 17, wherein the shielding facility comprises a magnetic shielding sheet.

19. The hearing device as claimed in claim 17, wherein the shielding facility comprises an induction coil.

20. The hearing device as claimed in one of claim 19, wherein the induction coil is connected in series with the converter.

21. The hearing device as claimed in claim 19, wherein the induction coil is arranged transversely to a magnetic axis of the converter.

22. The hearing device as claimed in claim 19, wherein the induction coil is an air-core coil.

23. The hearing device as claimed in one of claim 22, wherein the induction coil is connected in series with the converter.

24. The hearing device as claimed in claim 22, wherein the induction coil is arranged transversely to the magnetic axis of the converter.

25. The hearing device as claimed in one of claim 24, wherein the induction coil is connected in series with the converter.
